(19) United States
(12) Patent Application Publication
(10) Pub. No.: US 2015/0269582 A1
(43) Pub. Date: Sep. 24, 2015

(54) Credit Card Point of Service Payment Authorization System

(71) Applicant: Securus, LLC, Annapolis, MD (US)

(72) Inventor: Wayne S. Simmons, Annapolis, MD (US)

(21) Appl. No.: 14/717,386

(22) Filed: May 20, 2015

Related U.S. Application Data
(63) Continuation-in-part of application No. 13/694,469, filed on Dec. 4, 2012, now Pat. No. 9,043,224.
(60) Provisional application No. 61/630,125, filed on Dec. 5, 2011.

(51) Int. Cl. G06Q 20/40; G06Q 20/42; G06Q 20/24; G06Q 20/20

(52) U.S. Cl. CPC G06Q 20/4097; G06Q 20/202; G06Q 20/42; G06Q 20/24

(57) ABSTRACT

Systems and methods for secure verification of point of sale transactions to reduce fraudulent transactions are described herein. The system includes a backend communications module; a merchant point of sale network in communication with the backend communications module, adapted to transmit requests for authorization of a transaction and receive confirmation or denial of authorization of the transaction; a portable user device in communication with the backend communications module; a bank network in communication with the backend communications module, adapted to receive requests for authorization of transactions, determine if the user authorizes a transaction, and confirm or deny the transaction based on the user's authorization; and software executing on the portable user device adapted to pre-authorize transactions and authorize or deny a currently pending transaction. There is no direct communication between the merchant network, the portable user device, and the bank network.

### REFERENCE TO RELATED APPLICATIONS

The present application is a continuation in part of U.S. application Ser. No. 13/694,469, filed Dec. 4, 2012, and entitled “Credit Card Point of Service Payment Authorization System,” which claims priority to Provisional U.S. Application No. 61/630,125, filed Dec. 5, 2011, and entitled “Credit Card Point of Service Payment Authorization System,” both of which are incorporated in their entirety.

### BACKGROUND

1. Field of the Invention

The present invention relates in general to the problem of user verification and in particular to the problem of unauthorized credit card use and the reduction of the risk of fraud in point of sale credit card transactions.

2. Background of the Invention

Credit Cards are increasingly becoming popular, with an increasing customer base year on year because of the convenient and rewarding experience. Credit Card issuers offer frequent flier miles, reward points, and other rewarding perks to attract users for regular usage and to maintain their interest in using the credit card services.

The U.S. Census Bureau estimates that there are 181 million credit card holders in the United States. This represents approximately 77 percent of the adult population of the U.S.

According to Census Bureau estimates, there are more than 1.4 billion credit cards currently in circulation in the U.S., whose 2010 population is roughly 308.8 million.

These figures mean that there are about 4.5 credit cards for every man, woman and child in the United States, or an average of 7.7 credit cards for each of the 181 million people who actually hold credit cards.

The Federal Reserve reports that credit cards are used more than 20 billion times a year in the U.S., with the total value of these transactions at about $1.9 trillion.

Based on the number of transactions and the number of credit card holders, the average card holder uses a credit card 119 times a year, for transactions averaging $88 apiece.

This comes to an average annual total of about $10,500 in credit card purchases.

There are many players in the credit card market, but there are a handful of clear market share leaders. Based on projections from the Nilson Report based on the data collected by the U.S. Census Bureau, here is how the credit card market looked in 2010:

Three companies command 86 percent of all U.S. credit card purchase volume. Visa is the clear front-runner with an estimated 38.5 percent of annual purchase volume, followed by a close race for second and third place with MasterCard at 24.3 percent and American Express at 23.2 percent.

Other significant players in the credit card market include Discover, various store-issued credit cards, and various oil company credit cards.

Visa has the most U.S. cardholders at 111 million, followed by MasterCard at 98 million.

American Express has a much lower number of card holders, but compensates for it with an up-market focus. At 44 million U.S. cardholders, American Express not only trails Visa and MasterCard, but is edged out by Discover at 45 million. However, in terms of average annual purchase volume, American Express transactions total roughly $11,300 per card holder, compared with Visa at $7,300, MasterCard at $5,250, and Discover at $2,500.

Relative to their shares of purchase volume, Visa and MasterCard each have a disproportionate share of the debt outstanding, with Visa at 41.8 percent and MasterCard at 30.6 percent. In dollar terms, these portions of debt outstanding represent $388 billion and $284 billion, respectively.

The Mercator report estimates U.S. card issuers' total losses from credit- and debit-card fraud at $2.4 billion. That figure does not include losses that are borne by merchants, which probably run into tens of billions of dollars a year. These credit card fraud costs cardholders and credit card issuers as much as $500 million a year.

Credit Card POS losses take many forms, including:

Counterfeit Credit Card Fraud: This fraud accounts for 37% of all funds lost through credit card frauds. The fake card criminals use latest technology to skim information contained on credit cards.

Lost or Stolen Credit Card Fraud: Cards stolen from their cardholders or lost by them account for 23% of all card frauds. Often, cards are stolen from the workplace, gym, and unattended vehicles.

Identity Theft: Identity Theft has been on the rise in the recent years and can happen when criminals apply for credit card using someone else's credentials and personal information.

A 10-year low has been observed in the overall losses due to credit card frauds.

According to an annual study by Javelin Strategy & Research, the number of fraud victims decreased 28 per cent in 2010 from 11 million to 8.1 million. The total value of fraudulent losses also fell from $56 bn in 2009 to $37 bn in 2010. This has primarily happened because of the initiatives taken by the stakeholders of the banking industry to increase consumer awareness and hence prevent fraud.

However, billions of dollars of frauds are still happening at Point of Sale terminals because of non-involvement of the Card Holder.

Attempts to address this problem include Smart-Chip solutions, which use a card with an embedded microchip that requires the consumer to enter a unique PIN through a reader to make payment, and Near Field Communication Solutions which involve short distance wireless communication technology, which allows communication between two devices that either touch or are momentarily held close together.

The infrastructure required to enable these solutions is high and even using these solutions, fraud remains as demonstrated by the above statistics.

### SUMMARY OF THE INVENTION

The present invention overcomes the problems and disadvantages associated with current strategies and designs and provides systems and methods for credit card authorization.

One embodiment of the invention is directed to a system for secure verification of point of sale transactions to reduce fraudulent transactions. The system comprises a backend communications module; a merchant point of sale network in communication with the backend communications module, adapted to transmit requests for authorization of a transaction and receive confirmation or denial of authorization of the transaction; a portable user device in communication with the backend communications module; a bank network in communication with the backend communications module, adapted to receive requests for authorization of transactions, determine if the user authorizes a transaction, and confirm or deny the transaction based on the user's authorization; and software executing on the portable user device adapted to pre-authorize transactions and authorize or deny a currently pending transaction. There is no direct communication between the merchant network, the portable user device, and the bank network.

Preferably, the user is presented with the option of pre-authorizing transactions on multiple credit cards and pre-authorizing different amounts for each credit card. In a preferred embodiment, the authorization or pre-authorization is alternately completed via an interactive voice response (IVR) system. The pre-authorization preferably exists for a period of time chosen by the user. Preferably, the portable user device transmits at least one of the device's geographical location and the user's biometric data and the determination to confirm or deny the transaction is further based on at least one of the device's geographical location or the user's biometric data.

Another embodiment of the invention is directed to a method for securely verifying the authenticity of a request for authorization of payment in point of sale transactions to reduce fraudulent transactions. The method comprises, on a third party, independent backend communications module: receiving a request from a merchant point of sale system for authorization of a transaction; requesting approval or denial of the transaction from a bank; receiving one of an approval of the transaction, a denial of the transaction, or a notification that the transaction has not been pre-authorized; sending a signal requesting confirmation or denial of authorization to a mobile device of a user if the transaction has not been pre-authorized; receiving a confirmation or denial of authorization from the user; and responding to said merchant with an approval or a denial of authorization based on the bank's confirmation or denial of authorization or the user's confirmation or denial of authorization. There is no direct communication between the merchant point of sale system, the portable user device, and a bank.

In a preferred embodiment, the authorization or pre-authorization is alternately completed via an interactive voice response (IVR) system. Preferably, the pre-authorization exists for a period of time chosen by the user. Preferably, the method further comprises the portable user device transmitting at least one of the device's geographical location and the user's biometric data and the bank confirming or denying the transaction further based on at least one of the device's geographical location or the user's biometric data.

Another embodiment of the invention is directed to a method of securely authorizing point of sale transactions to reduce fraudulent transactions. The method comprises initiating an application on a portable user device; obtaining a selection from a user of a form of payment and a pre-authorized transaction amount; transmitting the selected form of payment and pre-authorized transaction amount to a third party, independent backend communications module; obtaining a request for authorization of a transaction from the third party, independent backend communications module if the transaction has not been pre-authorized; obtaining an authorization or denial of the transaction from the user; transmitting the authorization or denial to the third party, independent backend communications module; and displaying confirmation of completed transactions.

Preferably, the method further comprises displaying a list of all pending and completed transactions. In a preferred embodiment, the method further comprises obtaining a duration of pre-authorization from the user. Preferably, the method further comprises obtaining and transmitting at least one of the device's geographical location and the user's biometric data. Preerably, the third party, independent backend communications module communicates with a merchant and a bank to authorize the transactions and there is no direct communication between the merchant point of sale system, the portable user device, and the bank.

In a preferred embodiment, the authorization or pre-authorization is alternately completed via an interactive voice response (IVR) system. Preferably, the portable user device is one of a mobile phone, a smart watch, a fitness tracker, a device embedded in clothing, smart glasses, or a headset. Preferably, the form of payment is at least one of a credit card, a debit card, or an electronic payment.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 depicts an embodiment of the components of a user device.

FIG. 2 is a flow chart illustrating a generalized existing credit card purchase authorization system.

FIG. 3 illustrates an embodiment of the independent communication channels of the invention.

FIG. 4 illustrates an embodiment of an advanced authorization system.

FIG. 5 illustrates an embodiment of a POS authorization system.

FIGS. 6 and 7 illustrate embodiments of the general flow of data for a generic transaction, including authorization data flow.

FIG. 8 illustrates an embodiment of an implementation of the invention.

FIGS. 9 through 20 illustrate several examples of displays which used in the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

The invention described and claimed herein comprises a novel approach to reducing the risk of fraud in point of sale credit card transactions by providing independently-routed verification of the user's authorization by communication between the authorized user of record of the credit card and the issuer of the credit card through a trusted intermediary.

The term “credit card” is used to refer to any instrument by which an individual authorizes the request for an extension of credit or transfer of funds. It encompasses not only actual cards which are commonly referred to as “credit cards” but also debit cards and electronic “wands” and other tokens which are used to establish authority to extend credit or transfer funds.

The term “user” refers to the individual presenting the “credit card”; the term “user of record” refers to the individual who is authorized to request credit or the transfer of funds according to the records of the party extending credit or transferring funds pursuant to said request.

The term “POS” refers to a “Point of Sale” transaction.

In addition, the following abbreviations are used herein:

SRS: System Requirements Specification

XML: Extensible Mark-up Language

API: Application Programming Interface

Ad: Advertisement

CNS: Credit card Network System

BS: Banking system

POC: Proof of Concept

BS: Bank System

CNS: Credit card Network service

APNS: Applepush notification service

AT: Actual Transaction

The foregoing problems are overcome, and other advantages are provided by an independently-routed verification of authority through communication between an authorized user and an issuer of a credit card through a trusted intermediary in accordance with the invention. It should be noted that while the preferred embodiment is illustrated with respect to a credit card transaction, the problem and the solution disclosed herein are not limited to credit cards and the invention may also be used in general to verify that a transaction is being authorized by a user of record.

The fundamental weakness of the current system is that the system does not require that the card holder be involved anywhere in the payment process—the system only requires that the person claiming to have authority produce the credit card to the POS Merchant. The solution proposed in this disclosure is to involve the Authorized User and require an approval or rejection of any payment authorizations.

It is an object of the invention to provide a means by which an Authorized User is notified of a proposed transaction and authorizes or denies authorization of the transaction via an independent communications channel.

A principal feature of the invention is the independent communications channel, controlled by a trusted intermediary.

Another principal feature of the invention is the design of the independent communications channel so that there is no direct communication between any of the parties to the transaction all communications go to a third party trusted intermediary.

Among the advantages of the invention are the reduction in risk of fraud.

Note that in the preferred embodiment, a merchant is involved only at POS, the merchant does not interact with the Bank System and a communication module runs backend around the clock, without involvement of the User or Merchant.

These and other objects, features and advantages which will be apparent from the discussion which follows are achieved, in accordance with the invention, by providing a novel tool for use in point of sale credit card transactions for reducing the risk of fraud by providing independently-routed verification by communication between the authorized user of the credit card and the issuer of the credit card through a trusted intermediary.

The various features of novelty which characterize the invention are pointed out with particularity in the claims annexed to and forming a part of this disclosure. For a better understanding of the invention, its advantages and objects, reference is made to the accompanying drawings and descriptive matter in which a preferred embodiment of the invention is illustrated.

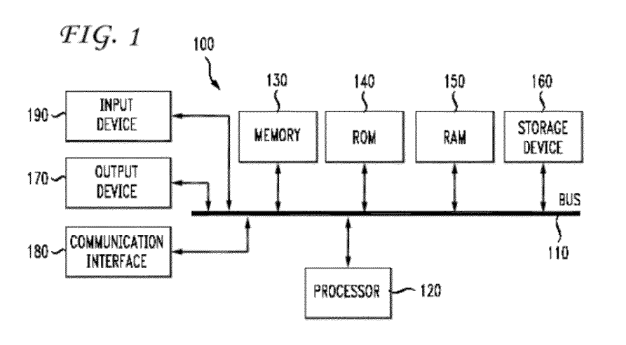

With reference to FIG. 1, an exemplary system includes at least one computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive, a solid state memory drive, or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, or a wireless devices, including smartphones (e.g., Research in Motion's Blackberry, Apple's iPhone, or a Google Android device), other wireless web-enabled phones, other wireless devices, wearable devices (e.g. smart watches, fitness trackers, devices embedded in clothing, smart glasses, or headsets) etc.

Although the exemplary environment described herein employs a hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include non-transitory computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

A preferred embodiment of the invention uses a smartphone. However, the invention can be used on any portable, web-enabled device For example, smart watches, smart glasses, fitness trackers, wearable devices, headsets, or other devices. Conceptually, there are two broad approaches: a pre-authorization approach and an “at POS” authorization approach.

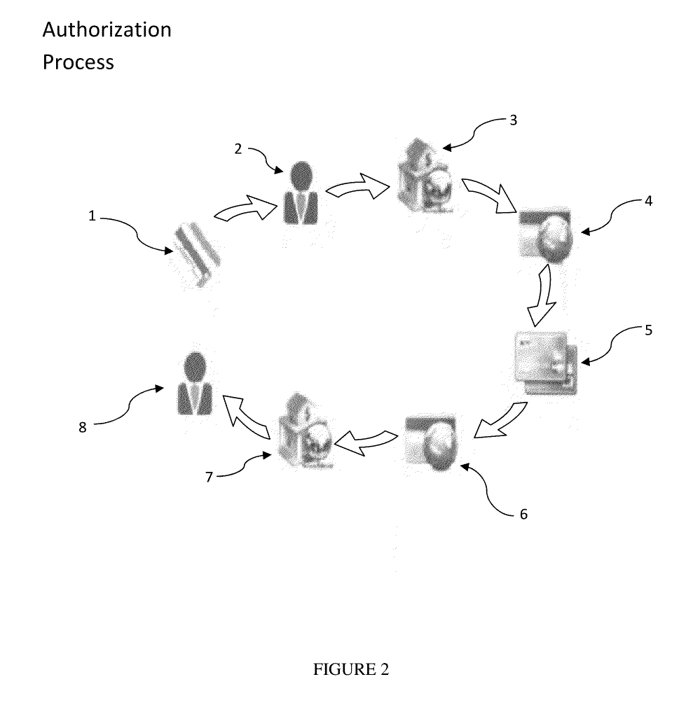

The starting point is the current system for authorizing credit card payments, illustrated in FIG. 2. The key stakeholders in this process are Point of Sale Merchants, a Merchant Bank, Card Service Provider, the Card Holder's Bank, and a Network Provider. The stakeholder best positioned to prevent fraud is the Credit Card Holder, yet under the current system, shown in FIG. 2, the card holder is not involved except for the moment when card holder hands over the credit card to the POS Merchant and therefore there is no assurance that the actual authorized user of record is actually involved in the authentication process of the credit card payment. Instead, as shown in FIG. 2, typically a cardholder presents a card to pay for a purchase at 1. The merchant processes the card and transaction information and requests authorization from the merchant's bank at 2. The merchant's bank submits the authorization request to the credit card network at 3. The credit card network, in turn, sends the authorization request to the card issuer at 4, who approves or declines the transaction at 5. The credit card network forwards the card issuer's authorization response to the merchant's bank at 6, who forwards the response to the merchant at 7. The merchant receives the authorization response and completes the transaction accordingly at 8.

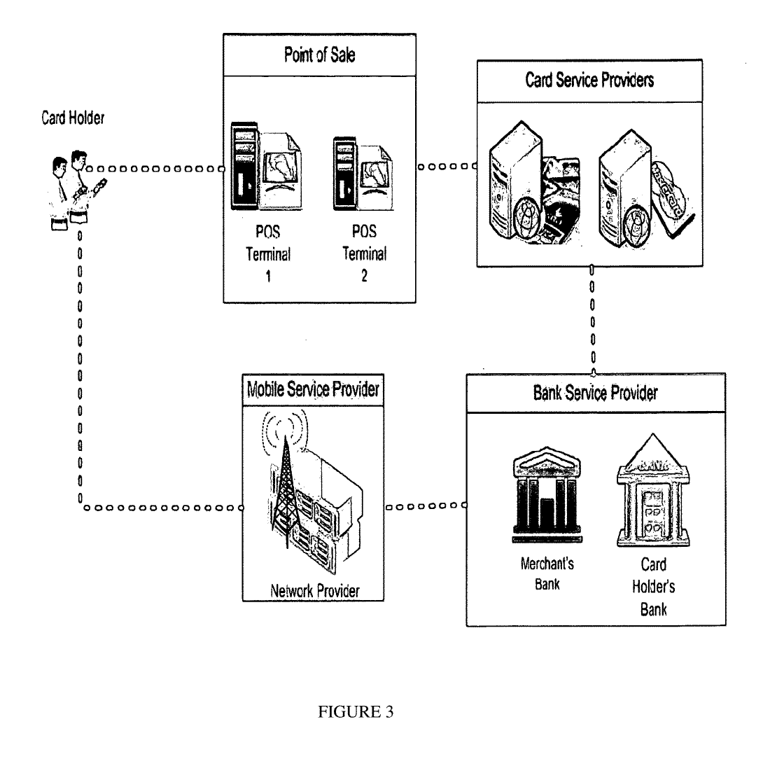

Involving the user of record in the process to authorize the payment preferably will add a level of security and enable reduction in credit card fraud. The approach is illustrated in FIG. 3. The fundamental approach of the invention is to preferably supply the Bank, the Credit Card Network Provider or a trusted intermediary with a user's registered mobile telephone number and to download the application described below to the user's mobile telephone. Optionally, the user may choose a pin for the application residing on their device, thereby providing an additional level of security. Preferably, all communications between the bank, user, merchant credit card network provider, and other parties are secure communications. While the invention is described in terms of credit card payments, the system can be implemented using other forms of payment. For example, debit cards, Apple Pay, Samsung Pay, Google Wallet, Paypal, Bitcoin, or another electronic payment form.

Since the user's mobile number is registered with the Bank or the Network Provider or the intermediary, whenever the pre-authorization request is sent by the card holder to the bank, the user's authentication is preferably verified.

The card holder preferably has data connectivity to use the application on their mobile device and communicate with the Bank system. In case there is no data connectivity, the user may have an option to utilize IVR.

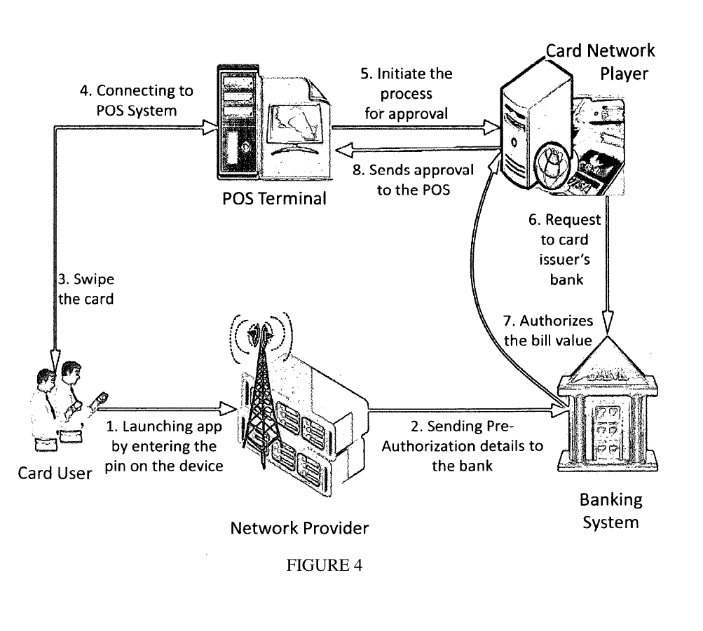

FIG. 4 illustrates an embodiment useful when an authorized user of record may be unable to communicate with the intermediary at the specific time when the transaction is to take place. In the Pre-Authorization approach, the card holder preferably authorizes the payment for a specific duration before the physical transaction is made. As shown in FIG. 4, a card user enters a pin on a mobile device at 1. Using the mobile device's network, the card user sends pre-authorization details to the card issuer's bank at 2. The card user then conducts a transaction with a merchant where the card is swiped at 3. The merchant's POS system accepts the transaction data at 4, and initiates the approval process at 5. The request for approval is sent via a card network to the card issuer's bank at 6. The card issuer's bank matches the pre-authorization to the request for approval and authorizes or denies the transaction at 7. The authorization or denial is then sent to the merchant's POS system via the card network at 8, where the transaction is completed accordingly.

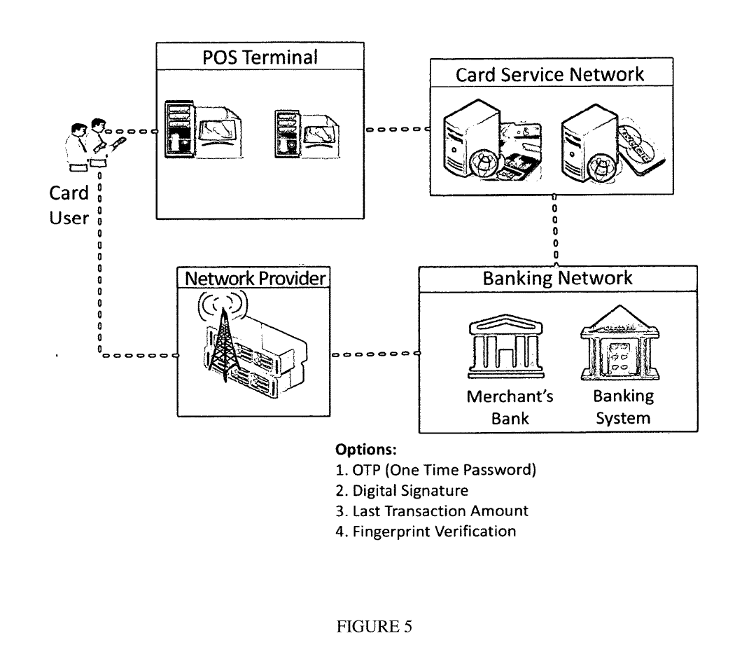

FIG. 5 illustrates an embodiment where authentication takes place at the point of sale and time of transaction. In this situation, the At-Authorization approach, the card holder preferably authorizes the payment just before the Credit Card issuer bank is contacted to authorize the payment. The At-Authorization approach can be implemented at both, Card Service Network and Banking Network level. The POC preferably implements the At-Authorization at Banking Network level. FIG. 5 shows the key stakeholders and flow of information between these stakeholders for the At-Authorization approach. The At-Authorization authentication process may additionally include the step of determining the user's geographical location (e.g. via the GPS in the users phone or by cellular triangulation). The user's geographical location may be used as an additional authentication step. For example, the user may indicate that they will be traveling or staying local for a period of time and any authorization acknowledgements or requests made in another location will be denied. Additionally, if the authorization acknowledgement occurs in a location that is not in a predefined proximity (e.g. within on mile, within half a mile, within 100 feet, or within 10 feet) to the location of the merchant requesting authorization, the system may deny the transaction.

At the time and point of authorization, the system may additionally capture and transmit biometric information of the user of the mobile device. This may include, but is not limited, to finger print data, retina scan, voice print data, heart rate data, or any other biometric information that may be captured by the mobile device or any wearable device (e.g. a watch, a fitness band, or a headset) that the user may have in his or her person. The system may use the biometric data in the decision to confirm or deny the transaction. For example, if the system determines that the user's heart rate is elevated the system may determine that the user is under duress and deny the transaction.

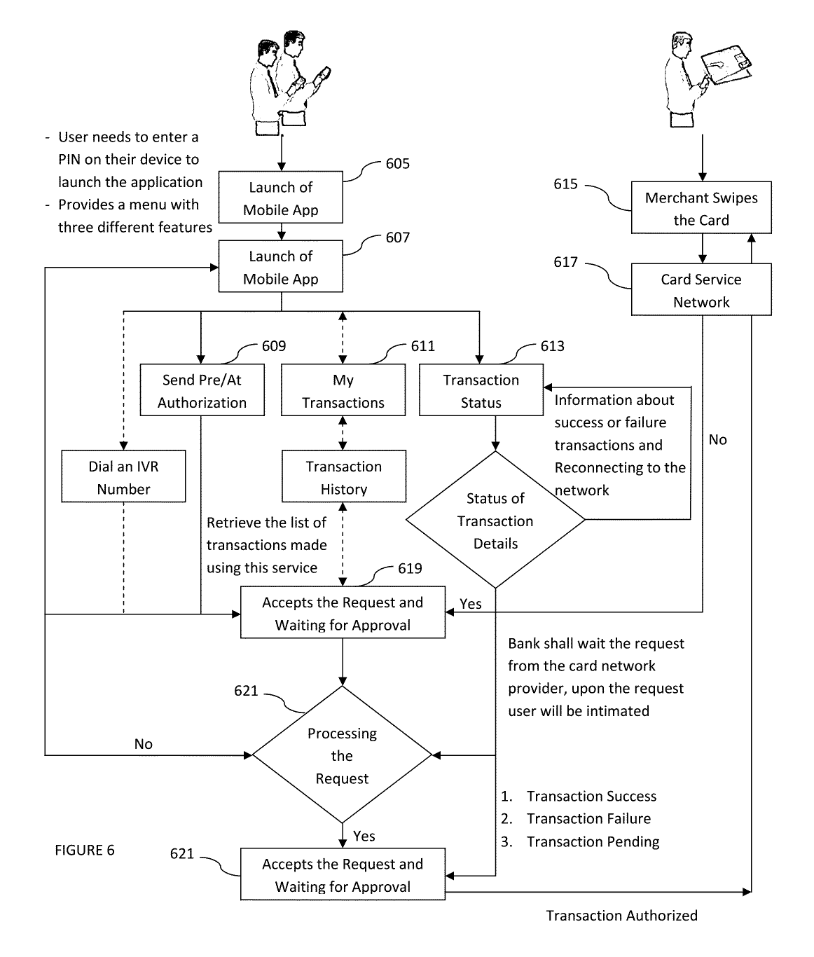

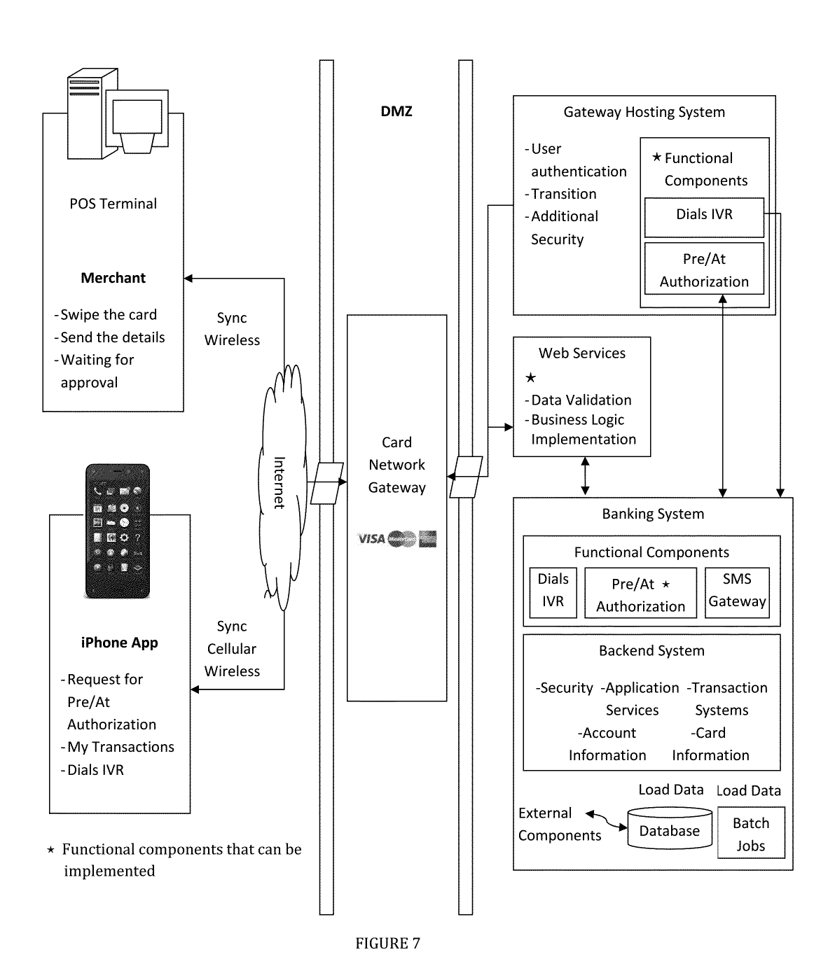

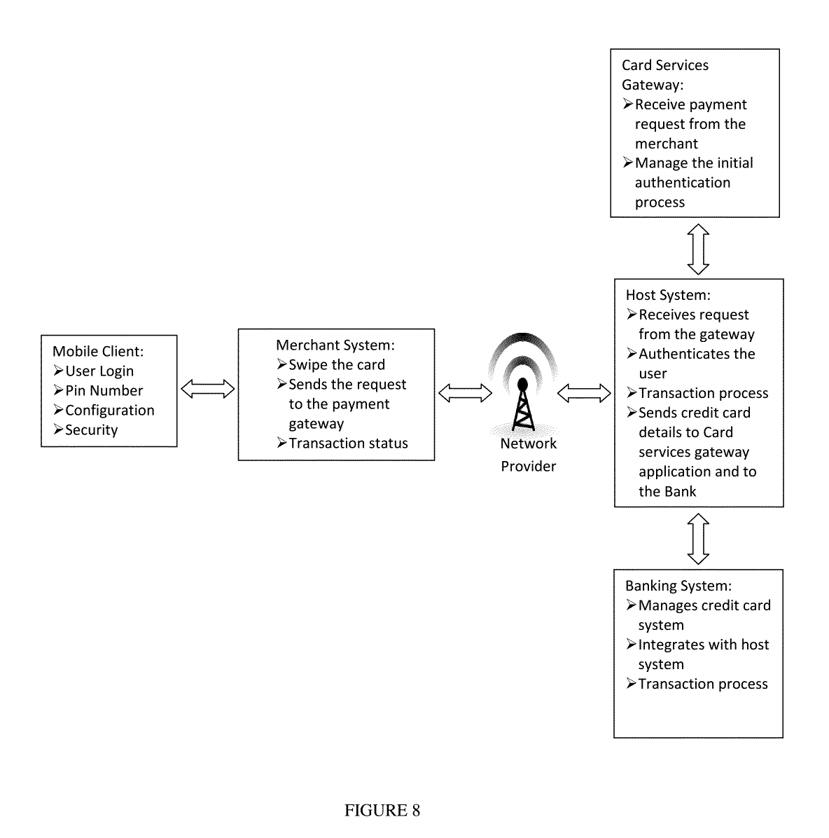

FIGS. 6 and 7 illustrate the general flow of data for a generic transaction, including authorization data flow. FIG. 6 is a flow chart of an embodiment of the authorization process. Examples of screen shots from various steps in the method depicted in FIG. 6 are shown in FIGS. 8-19. Either prior to or at the point of making a purchase a user launches an application (“app”) on their mobile phone or other web connected device 605. The app presents a home screen to the user 607 that provides the user with the options of setting an authorization 609, reviewing transaction history 611, and reviewing transaction status 613. At a transaction location, a merchant swipes the user's card or otherwise processes payment 615 and the merchant's POS system communicates with the card service network 617. The bank system receives the authorizations made by the user and the requests for authorization made by merchants 619. The bank system compares the requests for authorization from the merchants to the authorizations from the users and accepts or denies the transactions 621. The bank system then reports the decision back to the merchant to complete the transaction 623.

FIG. 7 illustrates an example of the lines of communication between the parties to the transaction. As can be seen in the figure, the Merchant, the User and the banking system do not directly communicate. The communications from and to both the Merchant and the User pass through a de-militarized zone (DMZ).

### EXAMPLES

In a preferred embodiment using an Apple iPhone™, the POC system would have 4 main components:

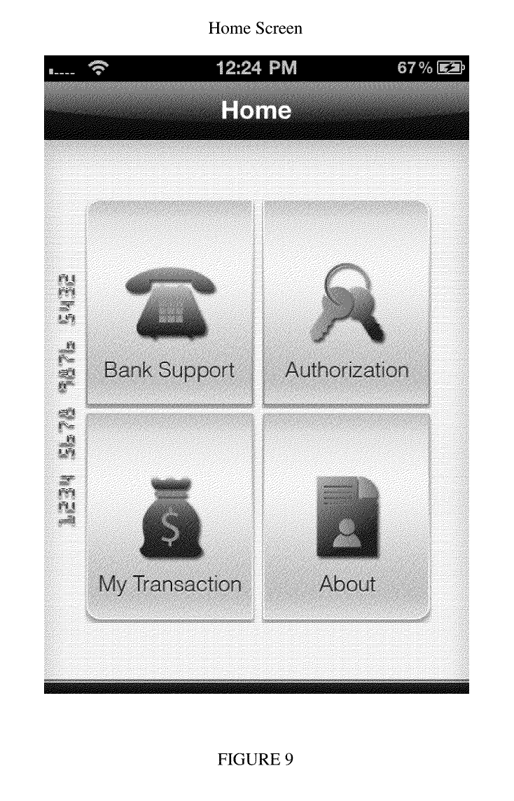

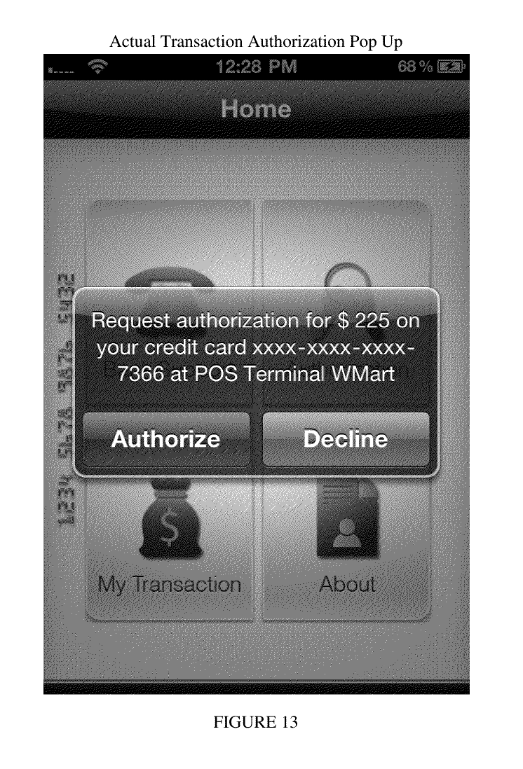

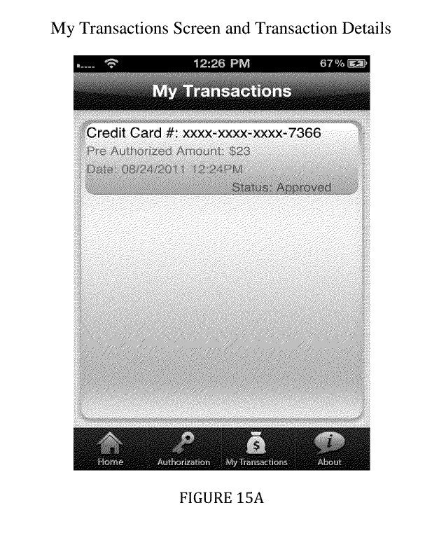

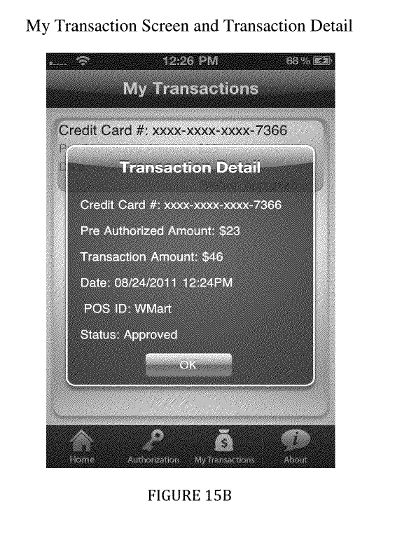

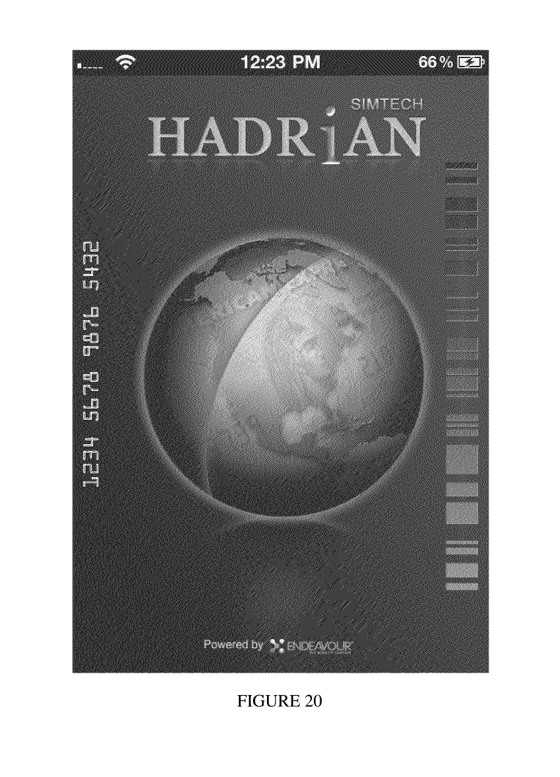

1) iPhonc POC. This application is used by the credit card user for pre-authorization, At authorization and view transactions and includes the following screens:
a. Splash Screen (FIG. 20)
b. Home Screen (FIG. 9)
c. Authorization Screen (FIG. 11)
   i. At Authorization pop up (FIG. 13)
d. About Screen
e. My Transaction Screen (FIG. 15A)
   i. Transaction History pop up (FIG. 15B)
f. Transaction Status pop up

2) POS

This model shall be responsible to initiate the card transaction and shall hold the information like card number, amount, date and status

3) CNS

CNS is a non UI service that acts as an bridge between POS and BS to transfer the information, since this is POC, CNS does not have any major responsibility associated with it except to transfer the transaction data between POS and BS
4) BS

BS is responsible to show the information received from POS and act on the transaction and return the response back to credit card user. BS involves itself in following type of requests:

a. Pre Authorization

This type of request is sent by credit card user prior to the transaction, typically a card swipe at POS. As soon as transaction is done by credit card user, BS preferably compares the Pre Authorization data and the original transaction data to authorize or decline the transaction and send the response back to iPhone application.

b. At Authorization

At Authorization is similar to Pre Authorization except that BS preferably does not have any prior information of transaction. A server check is preferably sent from iPhone application and BS responds back with At authorization information. iPhone application preferably pings the BS every minute (or other timeframe), once the user launches the application in order to get the appropriate response back to the client.

A prototype has been constructed with the following characteristics:

Pre Authorization/At Authorization

a. User launchs the app and successfully pre authorizes the transaction for specific amount and credit card

b. Bank sends an At authorization request to User

c. User receives successful authorization message

d. User receives failed/declined authorization message (BS sends failed/declined response), such as:
i. due to insufficient funds
ii. due to invalid data (like credit card number not matching with records etc.)
iii. due to network failure
iv. due to time out (both for pre and at authorization)

e. User receives transaction pending message, such as:
i. due to credit card service and bank link wait
ii.due to bank response wait

f. User sends a pre authorization for specific amount range, however in case bank receives payment exceeding or less than the amount range mentioned in pre authorization then bank sends an At authorization request to user for authorizing the payment

Card swiped twice for same amount, where in bank system can discard one transaction directly

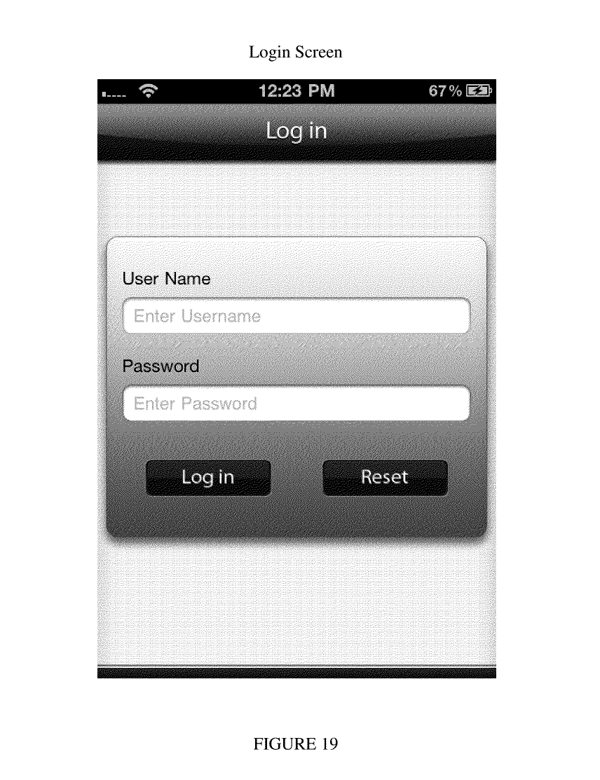

4. Login (FIG. 19)
a. User specifies proper username and password
b. User specifies wrong username/password

2. IVR
a. User enters correct information
b. User enters wrong credit card number
c. User enters wrong amount

Preferably, the Home Screen (FIG. 9) has the following four options available for the user:

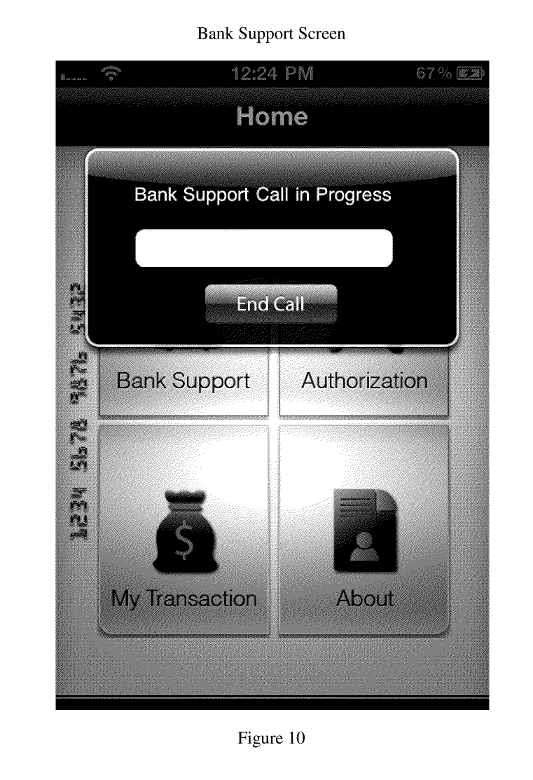

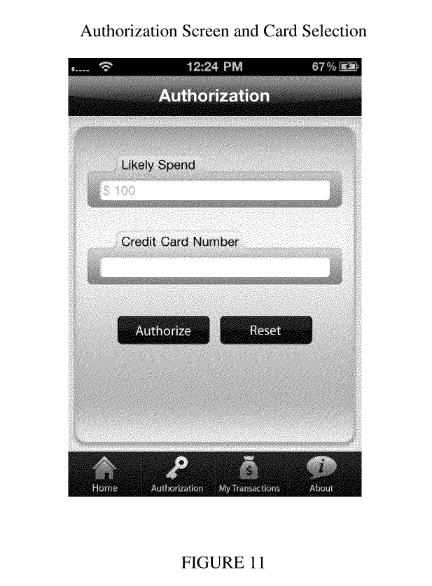

1. IVR screen (FIG. 10)

2. Pre/At Authorization screen

3. About

4. My Transactions

Functions called in this Class:

(void)loadView( )

(void)loadDialAnlVRScreen( )

(void)loadPreAtAuthorizationScreen( )

(void)loadMyTransactionsScreen( )

(void)dcalloc( )

An IVR Popup preferably has the following characteristics:

This class is preferably represented by Dial an IVR pop up of the application.

This class shall have one Field to input the credit card number, amount and an End call button.

Functions called in this Class:

(void)loadView( )

(void)dialAnIVRNumber( )

(void)dealloc( )

An Authorization Screen (FIG. 11) preferably has the following characteristics:

This class is preferably represented by Authorization screen of the application.

This class may have a slider to select the credit range and a picker field to select the available credit cards. User may be provided Authorize and Reset buttons.

Functions called in this Class:

(void)loadView( )

(void)resetControlValues( )

(void)placePreAuthorizationRequest( )

(void)dealloc( )

An At Authorization (FIG. 13) pop up preferably has the following characteristics:

This class is preferably represented by Transaction Authorization pop up for the transaction. Using which user can accept or decline the transaction.

Functions called in this Class

(void) initialize( )

(void) acceptTransaction( )

(void) declineTransaction( )

(void) dealloc( )

A My Transactions Screen (FIG. 15A) preferably has the following characteristics:

This class is preferably represented by My Transaction screen of the application.

This screen preferably shows all transactions of the user.

Functions called in this Class:

(void)loadView( )

(void)showSelectedTransactionHistory( )

(void)dealloc( )

A Transaction History Popup (FIG. 15B) has the following characteristics:

This class is preferably represented by Transaction History screen of the application.

This screen may show the transaction detail of the selected transaction.

Functions called in this Class:

(void) initialize( )

(void) getTransactionDetail( )

(void) dealloc( )

An About Screen has the following characteristics:

Functionality of the Class

This class is preferably represented by My Transaction screen of the application.

This screen shall show all transactions of the user.

Functions called in this Class:

(void)loadView( )

(void)showAboutInfo( )

(void)dealloc( )

A Transaction Status pop up has the following characteristics:

Functionality of the Class

This class is preferably represented by Transaction status of the transaction.

Functions called in this Class:

(void) initialize( )

(void) showTransactionStatusPopUp( )

(void) dealloc( )

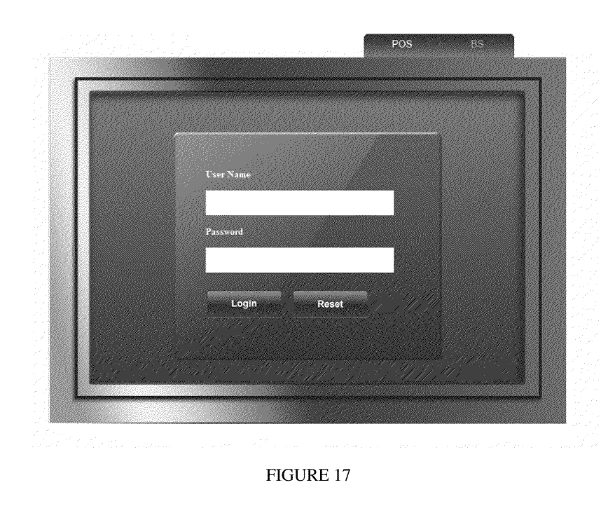

A Log-in Screen (FIG. 17) has the following characteristics

This class is preferably the entry-point of “BS” application and may be responsible for validating the supplied credentials. On successful validation gives access to BS screen.

Functions called in this Class:

(string)validate( )

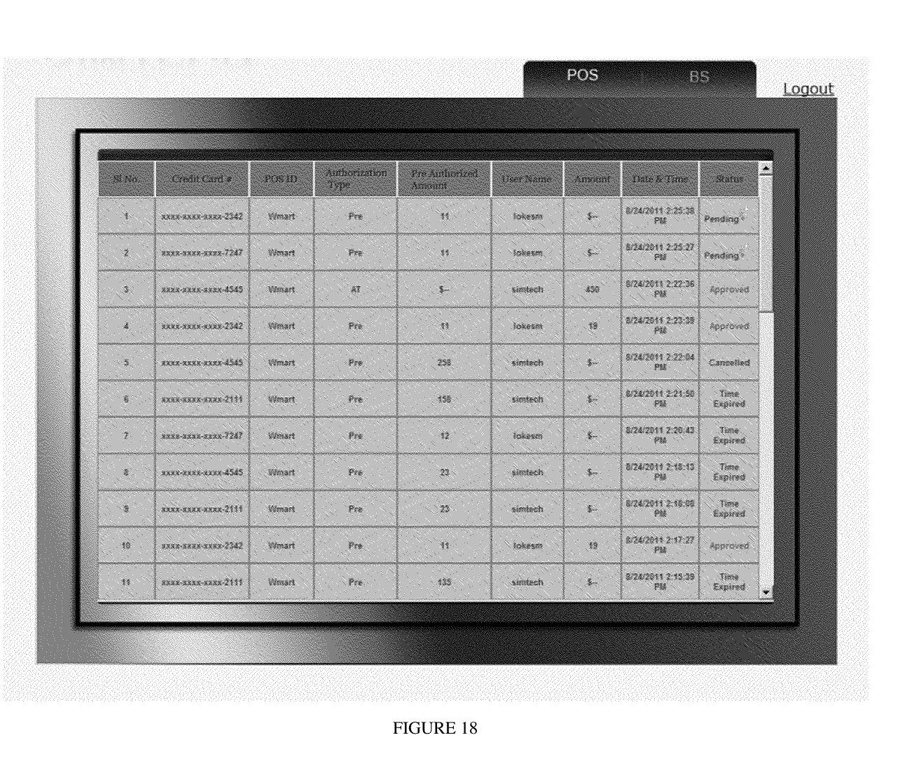

A POS Screen (FIG. 18) has the following characteristics:

This class is preferably the entry-point for POS terminal which captures card number, transaction amount and validates the data for transaction process.

Functions called in this Class:

(void) caputureData( )

(dataset) updateBS( )

(string) invokeService( )

(dataset) displayData( )

A BS Screen has the following characteristics

This class preferably authorizes or declines the transaction made by the user at POS terminal.

Functions called in this Class

(void) sendResponse( )

(string) recieveRequest( )

(void) validateData( )

A CNS Service has the following characteristics

This preferably is a the web method that acts as a middle tier and runs in the background which helps to interact POS with BS.

Functions called in this Class:

(void) sendBS( )

(string) recieveBS( )

Preferably, there are two types of interfaces: Internal Interface and External Interface. The following are the preferred embodiment of the internal interface presented in a “Simtech POC” application. This interface holds the static data for application like images, html contents (if any) and information about application.

The internal interface provides the GUI (Graphical User Interface) for the application. Through this interface user can interact with the application. It may also provide the navigation between different features of the application.

Program/Method Reference:

InitializeTheView: This method creates the view and its interface elements (if any).

loadView: This method loads the view with initialized interface elements.

In and out parameters:

In Parameters:

category_details: contains the details of selected tab/screen/button.

category_name: contains the name of the selected tab/screen/button.

Out Parameters:

view: contains the UI elements of the selected tab/screen/button details.

Runtime behaviour

iPhone app preferably communicates with BS server with the help of SOAP web services for pre and at authorizations.

iPhone Screens

2.1. Splash Screen (FIG. 20)

2.1.1 This screen will preferably be shown on each and every launch of application and after 3 seconds login screen is preferably displayed automatically.

Login Screen (FIG. 19)

2.1.2 Login screen preferably appears at every launch of application prompting user to input username and password to log-in to the application. The iPhone preferably receives the credit card numbers associated with the logged in user from BS which is displayed in Authorization screen for Pre Authorization process.

Home Screen (FIG. 9)

2.1.3. Home screen is preferably the main screen of the application, and contains four different options: IVR, Authorization, My Transactions and About.

Dial IVR (FIG. 10)

2.1.4. IVR preferably initiates a call process and has a field to enter the credit card number and amount. Call pop up preferably stays on screen for 10 seconds. There is preferably an end call button on the call pop up. If user clicks on end call button before 10 seconds the request process is terminated and a failure message is shown otherwise a successful message is shown.

Authorization Screen (FIG. 11)

This screen preferably allows a user to select the amount range and select the credit card from the picker control for sending a pre authorization request to BS.

My Transactions Screen (FIG. 15A)

This screen preferably shows all the transactions that have been done by a user in form of list, once the user selects particular transaction from the list, all the details shall be shown in a pop-up (FIG. 15B) related to selected transaction, for example:

Credit card number

Amount range if pre authorization

Actual amount

Date and Time

POS identification

Final status

About Screen

8.1.1. This screen preferably displays a description about iPhone POC and its version.

Transaction History/At Authorization Pop up

8.1.2. History pop up preferably shows the selected transaction details of a user and authorization pop up shall allow the user to authorize or decline particular transaction, especially At Authorization pulled from BS.

Simulation Model Screens

8.2. Log-in screen (FIG. 17)

8.2.1. This screen is preferably a log-in point for BS screen. Once a user logs-in successfully shall be shown a BS grid user interface with transaction information.

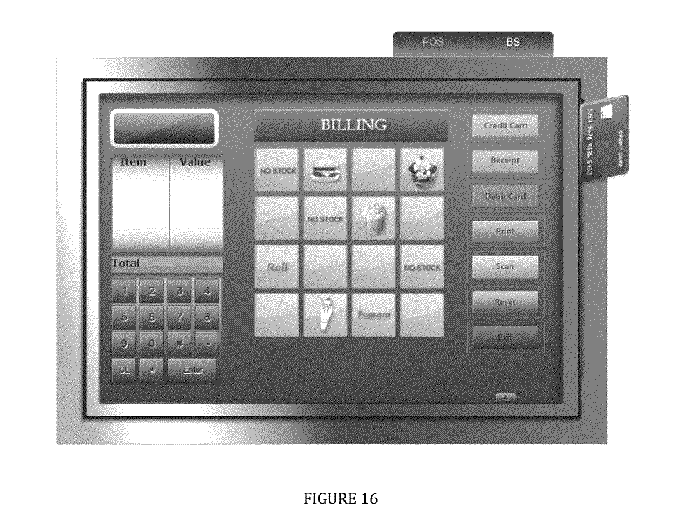

Simulated POS (FIG. 16)

8.2.2. This screen preferably contains two parts, once shall show an animation image representing a POS terminal where the card transaction happens along with an on screen key pad to enter the amount and execute the transaction. Once the transaction is executed user may be shown a grid UI with information like credit card number, amount, date and status.

Simulate BS

8.2.3. BS system is preferably be a grid UI reflecting all the information sent from POS and additional components, like user name. All the transaction authorizations are preferably automated processes showing the animated status accordingly.

Status Header

8.2.4. A header is preferably representing where the request is currently residing in form of a status bar, so that user can easily get to know the flow of the request.

FIG. 8 illustrates system level architecture.

Test Scenarios

A preferred embodiment was tested using the following components: iPhone 4, Dedicated Windows server and hosting space for Simulation model, .Net framework 2.0, Ajax extension 1.0, IrS 5.0 or above, and included the following:

App: an IPhone-4 application which communicated with the BS and allows a user to raise Pre-authorization for a specific amount for all the credit cards associated with specific user name and also receive authorization request from BS for the actual transactions happening at the POS. Based on user authorize or declining response the transaction shall be processed by the BS and update to POS.

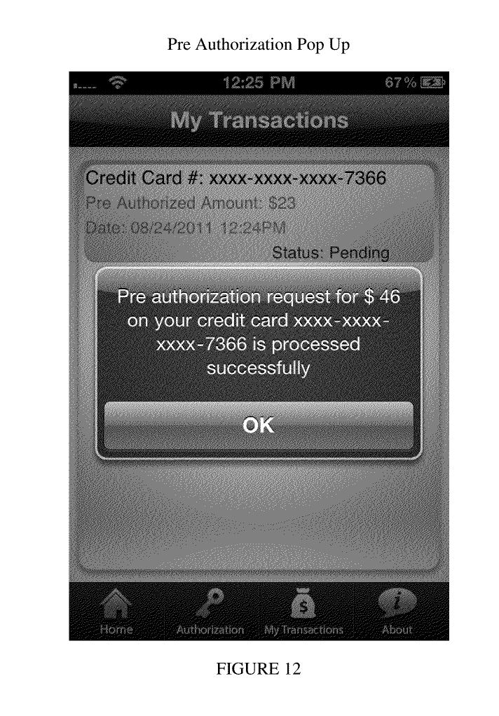

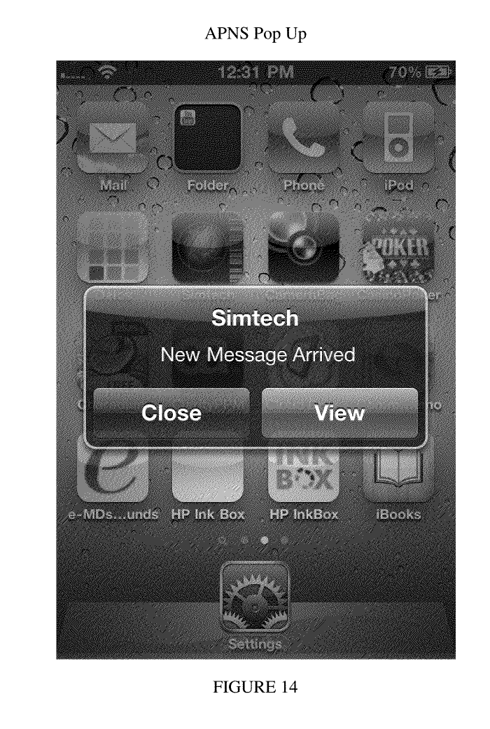

The i-phone application had the following screens: Splash screen (an example is shown in FIG. 20), Login screen (an example is shown in FIG. 19), Home screen (an example is shown in FIG. 9), bank Support screen (an example is shown in FIG. 10), authorization screen and card selection (an example is shown in FIG. 11), pre-authorization popup (an example is shown in FIG. 12), Actual Transaction authorization popup (an example is shown in FIG. 13), APNS popup (an example is shown in FIG. 14), and My transactions screen and transaction details (an example is shown in FIGS. 15A-B).

The system was tested using a simulated POS terminal to simulate a typical POS terminal where the billing happens and a transaction request sent to respective eNS and BS once the credit card is swiped and a Simulated eNS, which is a non UI simulated eNS which simply shall act as a bridge between POS and BS and a Simulated BS to simulate a bank system to show all the transactions and their status.

The capabilities and functioning of the invention are further illustrated in the following scenarios, which were tested:

Scenario 1

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Receives acknowledgement from BS

9. User performs transaction at POS with a credit card on which pre authorization request is placed

10. If actual transaction is within the limits of pre authorization request +$50, bank shall check and authorize the request directly

11. My Transactions screen shall be updated accordingly in app

Scenario 2

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Receives acknowledgement from BS

9. User performs transaction at POS with a credit card on which pre authorization request is placed

10. If actual transaction is more than the limit of pre auth request +$50 then the transaction shall be cancelled by BS and new AT request is sent to user

11. User receives AT pop up and can wither Authorize or decline the transaction

12. BS shall act accordingly based on user response

13. Sends appropriate response back to POS

Scenario 3

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Closes the app by clicking in device home button

9. User performs transaction at POS with a credit card on which pre authorization request is placed

10. If actual transaction is within the limits of pre Auth request +$50, bank shall check and initiate APNS notification

11. User receives the notification when clicked on ‘View’ app launches and user inputs proper user name and password

12. Receives pre authorization pop up

13. BS shall process the transaction and send the response to POS

14. My Transactions screen shall be updated accordingly in app

Scenario 4

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Closes the app by clicking in device home button

9. User performs transaction at POS with a credit card on which pre authorization request is placed

10. If actual transaction is above the limit of pre authorization request +S50, BS shall cancel the transaction, initiate AT request and sends APNS notification

11. User receives the APNS notification with View and Close buttons, when clicked on ‘View’ app launches and user inputs proper user name and password. If clicked on ‘Close’ nothing happens and BS shall wait for specified time and cancel the transaction

12. Receives AT authorization pop up

13. BS shall process the transaction based on user response and send the response to POS

14. My Transactions screen shall be updated accordingly in app

Scenario 5

1. User launches the application on the iPhone

2. Types proper username and password in the Login screen

3. Home screen is shown with available options based on user validation and credit cards associated with user

4. User performs actual transaction at POS with a credit card

5. BS shall initiate AT request and sends APNS notification

6. User receives the AT pop up and shall authorize or decline the request

7. BS shall process the transaction based on user response and send the response to POS

8. My Transactions screen shall be updated accordingly in app

Scenario 6

1. User docs not launch the app

2. User performs actual transaction at POS with a credit card 3. BS shall initiate AT request and sends APNS notification

4. User receives APNS notification pop up with ‘View’ and ‘Close’ options

5. When clicked on View, application launches and user types proper username and password. If clicked on ‘Close’ button nothing happens and after some time transaction shall be cancelled by BS and updates to POS

6. Receives AT transaction pop where user can authorize or decline the transaction

7. BS shall receive the response and update POS accordingly

8. My Transactions screen shall be updated accordingly in Hadrian app

Scenario 7

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Receives acknowledgement from BS

9. Performs actual transaction at POS

10. If actual transaction is more than the limit of pre auth request +$50 then the transaction shall be cancelled by BS and new AT request is sent to user

11. User enters a dead zone where there is no internet available or does not respond to the transaction request sent by BS

12. BS shall wait for 2 minutes for user response and if not received shall send a pass code request to POS terminal

13. User should enter the credit card pin at the POS terminal manually to authorize the transaction

14. BS shall act accordingly based on user response

15. Sends appropriate response back to POS

Scenario 8

1. User launches the app

2. Types proper username and password

3. Finds Bank support and authorization buttons in active home screen

4. This is because either user is not associated with any credit cards or credit cards expired

5. User shall be able to only see the My transactions page

Scenario 9

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. If insufficient funds on the card then BS shall send back appropriate response and cancels the request placed

Scenario 10

1. User launches the application on the iPhone

2. Types proper username and password in the Login screen

3. Home screen is shown with available options based on user validation and credit cards associated with user

4. Selects Authorization screen

5. Enters likely spend amount

6. Selects the credit cards from the list associated

7. Clicks Authorize button to send the pre authorization request to BS

8. Receives acknowledgement from BS

9. Performs actual transaction at POS

10. If actual transaction is more than the available credit limit on the card then BS shall cancel the transaction

11. Update user and POS accordingly

Thus, there has been described a novel solution for reducing the risk of fraud in point of sale credit card transactions by providing independently-routed verification by communication between the authorized user of the credit card and the issuer of the credit card through a trusted intermediary, that has a number of novel features, and a manner of making and using the invention.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A system for secure verification of point of sale transactions to reduce fraudulent transactions, comprising:
a backend communications module;
a merchant point of sale network in communication with the backend communications module, adapted to transmit requests for authorization of a transaction and receive confirmation or denial of authorization of the transaction;
a portable user device in communication with the backend communications module;
a bank network in communication with the backend communications module, adapted to receive requests for authorization of transactions, determine if the user authorizes a transaction, and confirm or deny the transaction based on the user's authorization; and
software executing on the portable user device adapted to pre-authorize transactions and authorize or deny a currently pending transaction;
wherein there is no direct communication between the merchant network, the portable user device, and the bank network.

2. The system of claim 1, wherein the user is presented with the option of pre-authorizing transactions on multiple credit cards.

3. The system of claim 2, wherein the user is presented with the option of pre-authorizing different amounts for each credit card.

4. The system of claim 1, wherein the authorization or pre-authorization is alternately completed via an interactive voice response (IVR) system.

5. The system of claim 1, wherein the pre-authorization exists for a period of time.

6. The system of claim 5, wherein the period of time is chosen by the user.

7. The system of claim 1, wherein the portable user device transmits at least one of the device's geographical location and the user's biometric data and the determination to confirm or deny the transaction is further based on at least one of the device's geographical location or the user's biometric data.

8. A method for securely verifying the authenticity of a request for authorization of payment in point of sale transactions to reduce fraudulent transactions, comprising, on a third party, independent backend communications module:
receiving a request from a merchant point of sale system for authorization of a transaction;
requesting approval or denial of the transaction from a bank;
receiving one of an approval of the transaction, a denial of the transaction, or a notification that the transaction has not been pre-authorized;
sending a signal requesting confirmation or denial of authorization to a mobile device of a user if the transaction has not been pre-authorized;
receiving a confirmation or denial of authorization from the user; and
responding to said merchant with an approval or a denial of authorization based on the bank's confirmation or denial of authorization or the user's confirmation or denial of authorization;
wherein there is no direct communication between the merchant point of sale system, the portable user device, and a bank.

9. The method of claim 8, wherein the authorization or pre-authorization is alternately completed via an interactive voice response (IVR) system.

10. The method of claim 8, wherein the pre-authorization exists for a period of time.

11. The method of claim 10, wherein the period of time is chosen by the user.

12. The method of claim 8, further comprising the portable user device transmitting at least one of the device's geographical location and the user's biometric data and the bank confirming or denying the transaction further based on at least one of the device's geographical location or the user's biometric data.

13. A method of securely authorizing point of sale transactions to reduce fraudulent transactions, comprising:
initiating an application on a portable user device;
obtaining a selection from a user of a form of payment and a pre-authorized transaction amount;
transmitting the selected form of payment and pre-authorized transaction amount to a third party, independent backend communications module;
obtaining a request for authorization of a transaction from the third party, independent backend communications module if the transaction has not been pre-authorized;
obtaining an authorization or denial of the transaction from the user;
transmitting the authorization or denial to the third party, independent backend communications module; and
displaying confirmation of completed transactions.

14. The method of claim 13, further comprising displaying a list of all pending and completed transactions.

15. The method of claim 13, further comprising obtaining a duration of pre-authorization from the user.

16. The method of claim 13, further comprising obtaining and transmitting at least one of the device's geographical location and the user's biometric data.

17. The method of claim 13, wherein the third party, independent backend communications module communicates with a merchant and a bank to authorize the transactions and there is no direct communication between the merchant point of sale system, the portable user device, and the bank.

18. The method of claim 13, wherein the authorization or pre-authorization is alternately completed via an interactive voice response (IVR) system.

19. The method of claim 13, wherein the portable user device is one of a mobile phone, a smart watch, a fitness tracker, a device embedded in clothing, smart glasses, or a headset.

20. The method of claim 13, wherein the form of payment is at least one of a credit card, a debit card, or an electronic payment.
